(19) United States
(12) Patent Application Publication
(10) Pub. No.: US 2025/0087668 A1
(43) Pub. Date: Mar. 13, 2025

(54) NEGATIVE ELECTRODE AND METHOD OF PRODUCING THE SAME, AND NON-AQUEOUS ELECTROLYTE SECONDARY BATTERY INCLUDING NEGATIVE ELECTRODE AND METHOD OF PRODUCING THE SAME

(71) Applicant: Prime Planet Energy & Solutions, Inc., Tokyo (JP)

(72) Inventors: Ryoki KIHARA, Kobe-shi (JP); Natsumi OZASA, Amagasaki-shi (JP); Hideki SANO, Osaka (JP)

(21) Appl. No.: 18/795,182

(22) Filed: Aug. 6, 2024

(30) Foreign Application Priority Data
Sep. 7, 2023 (JP) 2023-145314

(51) Int. Cl. H01M 4/1393; H01M 4/02; H01M 4/133; H01M 4/36; H01M 4/587; H01M 4/62

(52) U.S. Cl. CPC H01M 4/1393; H01M 4/133; H01M 4/366; H01M 4/587; H01M 4/622; H01M 2004/027

(57) ABSTRACT

A negative electrode for a non-aqueous electrolyte secondary battery comprises an active material layer including active material particles. The active material particles include carbon-based active material particles and metal-based active material particles. The active material layer has a connecting portion connecting a pair of the active material particles to each other. The connecting portion has a first layer including at least one of polyacrylic acid and a salt thereof as well as a second layer formed on a surface of the first layer and including styrene-butadiene rubber. Both the first layer and the second layer are in contact with surfaces of the pair of the active material particles connected by the connecting portion.

### CROSS REFERENCE TO RELATED APPLICATIONS

This nonprovisional application is based on Japanese Patent Application No. 2023-145314 filed on Sep. 7, 2023, with the Japan Patent Office, the entire contents of which are hereby incorporated by reference.

### BACKGROUND OF THE INVENTION

### Field of the Invention

The present invention relates to a negative electrode and a method of producing the same, and a non-aqueous electrolyte secondary battery including a negative electrode and a method of producing the same.

### Description of the Background Art

It is known that it is possible to increase the capacity of a negative electrode of a non-aqueous electrolyte secondary battery by using a combination of graphite and a Si-based active material, such as SiOx, which is superior to graphite in increasing capacity (see Japanese Patent Laying-Open No. 2015-53152 and International Patent Laying-Open No. WO 2017/026268, for example). As compared to graphite, a Si-based active material expands and shrinks to a great extent during charge and discharge of the secondary battery, which tends to cause a decrease of electronic conductivity in the active material layer and tends to cause a degradation of post-charge/discharge-cycle capacity retention.

Japanese Patent Laying-Open No. 2015-53152 discloses use of polyacrylic acid to reduce expansion and shrinkage of a secondary battery that can occur during charge and discharge. International Patent Laying-Open No. WO 2017/026268 discloses forming a polyacrylic acid covering layer on carbon-based active material and Si-based active material and optimizing the content ratio of the polyacrylic acid to reduce expansion of a secondary battery and inhibit a decrease of discharged capacity.

### SUMMARY OF THE INVENTION

Secondary batteries are also demanded to have further enhanced cycling performance. An object of the present disclosure is to provide a negative electrode that makes it possible to produce a secondary battery with excellent cycling performance, a method of producing the negative electrode, and a non-aqueous electrolyte secondary battery including the negative electrode and a method of producing the same.

[1] A negative electrode for a non-aqueous electrolyte secondary battery, comprising:
an active material layer including active material particles, wherein
the active material particles include carbon-based active material particles and metal-based active material particles,
the active material layer has a connecting portion connecting a pair of the active material particles to each other,
the connecting portion has a first layer including at least one of polyacrylic acid and a salt thereof as well as a second layer formed on a surface of the first layer and including styrene-butadiene rubber, and
both the first layer and the second layer are in contact with surfaces of the pair of the active material particles connected by the connecting portion.

[2] The negative electrode according to [1], wherein the carbon-based active material particles include graphite particles.

[3] The negative electrode according to [1] or [2], wherein the metal-based active material particles include particles of one or more types selected from the group consisting of Si, SiOx, and a Si—C composite.

[4] The negative electrode according to any one of [1] to [3], wherein the connecting portion at least connects the carbon-based active material particle with the metal-based active material particle.

[5] The negative electrode according to any one of [1] to [4], wherein the active material layer further includes a conductive aid.

[6] The negative electrode according to any one of [1] to [5], wherein the active material layer further includes carboxymethylcellulose.

[7] A non-aqueous electrolyte secondary battery comprising the negative electrode according to any one of [1] to [6].

[8] A method of producing a negative electrode for a non-aqueous electrolyte secondary battery, the negative electrode having an active material layer including active material particles, the method comprising:
a first step to obtain a mixed-kneaded body;
a second step to obtain a slurry by using the mixed-kneaded body; and
a third step to form the active material layer by using the slurry, wherein
the first step includes a step to mix and knead active material particles, a polyacrylic acid hydrate obtainable by hydration of at least one of polyacrylic acid and a salt thereof, and water,
the active material particles include carbon-based active material particles and metal-based active material particles,
the second step includes a step to add styrene-butadiene rubber and water to the mixed-kneaded body and mix and knead, and
when an ideal solid content B0 [weight %] is defined as a solid content of a mixture of the active material particles and the at least one of polyacrylic acid and a salt thereof mixed in the same ratio as in the mixed-kneaded body at which a torque produced by mixing and kneading the mixture with addition of water thereto reaches maximum,
a solid content of the mixed-kneaded body is from (B0-5) to B0 [weight %], and
a solid content of the slurry is from (B0-25) to (B0-10) [weight %].

[9] The method of producing a negative electrode according to [8], wherein the step to mix and knead in the first step is carried out with further addition of carboxymethylcellulose.

[10] The method of producing a negative electrode according to [8] or [9], wherein the step to mix and knead in the first step is carried out with further addition of a conductive aid.

[111] The method of producing a negative electrode according to any one of [8] to [10], wherein the carbon-based active material particles include graphite particles.

[12] The method of producing a negative electrode according to any one of [8] to [11], wherein the metal-based active material particles include particles of one or more types selected from the group consisting of Si, SiOx, and a Si—C composite.

[13] A method of producing a non-aqueous electrolyte secondary battery, the method comprising a step to produce a negative electrode by the method of producing a negative electrode according to any one of [8] to [12].

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a flowchart illustrating a method of producing a negative electrode according to an embodiment.

FIG. 2 is a scanning transmission electron microscope image of an active material layer obtained in Example 1.

FIG. 3 is a scanning transmission electron microscope image of an active material layer obtained in Example 2.

FIG. 4 is a scanning transmission electron microscope image of an active material layer obtained in Comparative Example 1.

FIG. 5 is a scanning transmission electron microscope image of an active material layer obtained in Comparative Example 2.

### DESCRIPTION OF THE PREFERRED EMBODIMENTS

Herein, a numerical range such as “from x to y” includes the upper limit and the lower limit, unless otherwise specified. That is, “from x to y” means a numerical range of “not less than x and not more than y”. Any numerical value selected from a certain numerical range may be used as a new upper limit or a new lower limit. For example, any numerical value from a certain numerical range may be combined with any numerical value described in another location of the present specification or in a table or a drawing to set a new numerical range.

### (Negative Electrode)

A negative electrode according to the present embodiment (hereinafter also called “the present negative electrode”) is a negative electrode for a non-aqueous electrolyte secondary battery (hereinafter also called “a secondary battery”), and it has an active material layer that includes active material particles. The active material particles include carbon-based active material particles (hereinafter also called “carbon-based particles”) and metal-based active material particles (hereinafter also called “metal-based particles”). The active material layer has a connecting portion connecting a pair of the active material particles to each other. The connecting portion has a first layer that includes at least one of polyacrylic acid and a salt thereof (hereinafter also called “PAA”), as well as a second layer that is formed on a surface of the first layer and includes styrene-butadiene rubber (hereinafter also called “SBR”). Both the first layer and the second layer are in contact with surfaces of the pair of the active material particles connected by the connecting portion.

Preferably, the carbon-based particles, which are active material particles, include particles of one or more types selected from the group consisting of carbon materials such as graphite, hard carbon, soft carbon, and amorphous-coated graphite, or they are particles of one or more types selected from this group; preferably, they include graphite particles, or they are graphite particles.

The metal-based particles, which are active material particles, include particles of a metallic element such as an elemental metal or a metal oxide including an element selected from the group consisting of silicon (Si), tin (Sn), antimony (Sb), bismuth (Bi), titanium (Ti), and germanium (Ge). Preferably, the metal-based particles include particles of one or more types selected from the group consisting of Si, SiOx (x=0.5 to 1.5), a Si—C composite (hereinafter also called “a SiC composite”), and Sn, or they are particles of one or more types selected from this group; more preferably, they include particles of one or more types selected from the group consisting of Si, SiOx, and a SiC composite, or they are particles of one or more types selected from this group. Further preferably, the metal-based particles are SiC composite particles. The SiC composite is, for example, a composite in which Si is dispersed in a carbon matrix.

The average particle size, D50, of the metal-based particles is from 3 to 15 μm, for example, preferably from 5 to 10 μm. The average particle size D50 herein refers to the particle size in volume-based particle size distribution at which cumulative frequency of particle sizes accumulated from the small size side reaches 50%. The volume-based particle size distribution can be measured with a laser-diffraction particle size distribution analyzer.

The total content of the carbon-based particles and the metal-based particles included in the active material particles may be from 90 to 100 weight %, or may be from 90 to 99 weight %, or may be from 92 to 95 weight % of all the active material particles. As for the ratio between the carbon-based particles and the metal-based particles in the active material particles, the weight ratio of (carbon-based particles):(metal-based particles) may be from 70:30 to 95:5, or may be from 80:20 to 92:8, or may be from 85:15 to 95:5.

The present negative electrode may have the active material layer on its negative electrode current collector. The active material layer may be formed on only one side of the negative electrode current collector, or may be formed on both sides thereof. The negative electrode current collector is a metal foil that is made by using a copper material such as copper and copper alloy, for example.

When the active material layer is formed on both sides of the negative electrode current collector, the mass of the active material layer per unit area for both sides (the sum of both sides) may be from 150 to 250 g/m², or may be from 170 to 230 g/m², or may be from 180 to 220 g/m², for example. The mass per unit area of the negative electrode current collector per one side can be regarded as half the above-mentioned mass per unit area for both sides, for example. The thickness of the active material layer per one side may be from 90 to 200 μm, or may be from 100 to 180 μm, or may be from 110 to 150 μm, for example. The packing density of the active material layer can be calculated by the following equation, and may be from 1.3 to 1.9 g/cc, or may be from 1.4 to 1.8 g/cc, or may be from 1.5 to 1.7 g/cc, for example.

$$Packing density [ g / cc ] = ( Mass of active material layer per unit area [ g / {m}^{2} ] ) / ( Thickness of active material layer [ μ m ] )$$

The active material layer has a connecting portion, and the connecting portion connects two active material particles to each other in the active material layer. With the active material layer having the connecting portion, conductive paths are readily formed between the active material particles with the help of a conductive aid and/or the like. The connecting portion of the present negative electrode has a first layer, and also has a second layer that is formed on the surface of the first layer. In the present negative electrode, both the first layer and the second layer are in contact with the surfaces of the active material particles, and thereby the connecting portion is capable of connecting the active material particles to each other with both the first layer and the second layer. The presence of the first layer and the second layer of the connecting portion can be checked in a scanning transmission electron microscope image (hereinafter also called “an SEM image”), and/or by examining spectrum distribution of an SEM-EDX (energy dispersive X-ray spectroscopy) spectrum, for example.

The length of the connecting portion (the size thereof in the direction connecting two active material particles) may be from 0.1 to 5 μm, or may be from 0.5 to 4 μm, or may be from 1 to 3 μm. The diameter of the connecting portion may be from 0.1 to 1 μm, or may be from 0.2 to 0.9 μm, or may be from 0.3 to 0.8 μm. The length and the diameter of the connecting portion can be determined by analysis of an SEM image.

The first layer includes PAA. The PAA may be either in acid form (polyacrylic acid) or in salt form (polyacrylic acid salt), or may include both; preferably it includes a salt form. The PAA is preferably in salt form. Examples of the salt include salts of an alkali metal such as potassium and sodium. PAA has excellent binding capability and can confer mechanical strength (hardness) to the connecting portion, making it easier to maintain the distance between two active material particles.

As a result, even when the active material particles expand and shrink during charge and discharge of the secondary battery, the distance between two active material particles can be maintained small and, thereby, conductivity of the active material layer tends to be ensured.

The second layer is simply required to be formed on the surface of the first layer, and, preferably, it is formed to cover the entire surface of the first layer in such a manner that the first layer is covered without any exposure of the surface of the first layer. The second layer includes SBR. SBR has excellent flexibility, so it is capable of forming a connecting portion that can follow the expansion and shrinkage of the active material particles during charge and discharge of the secondary battery.

When the connecting portion has the first layer and the second layer as described above, as compared to when PAA and SBR are mixed in the connecting portion, the distance between the active material particles can be maintained small even when the active material particles expand and shrink during charge and discharge of the secondary battery, and, also, the connecting portion tends not to be cut. Moreover, the connecting portion can connect between two active material particles that are located relatively far from each other in the active material layer. As a result, conductive paths are readily formed in the active material layer with the help of a conductive aid and/or the like, and, thereby, a secondary battery with excellent cycling performance tends to be obtained. The connecting portion having the first layer and the second layer is obtained by the below-described method of producing a negative electrode, for example.

The two active material particles connected by the connecting portion may be two carbon-based particles, or may be two metal-based particles, or may be a carbon-based particle and a metal-based particle. As compared to carbon-based particles, metal-based particles undergo a great extent of expansion and shrinkage during charge and discharge of the secondary battery. As compared to a connecting portion between two carbon-based particles, a connecting portion between a metal-based particle and another active material particle (between a carbon-based particle and a metal-based particles, or between two metal-based particles) tends to be cut during charge and discharge of the secondary battery. In the present negative electrode, the connecting portion has the first layer with excellent hardness and the second layer with excellent flexibility, and therefore the connecting portion can have a proper degree of strength and flexibility. As a result, even when at least one of the two active material particles connected by the connecting portion is a metal-based particle, the connecting portion is not easily cut during charge and discharge of the secondary battery.

The content of PAA and SBR in the connecting portion, which is PAA:SBR (volume ratio), is preferably from 1:1.2 to 1:15, and may be from 1:1.25 to 1:12, or may be from 1:1.3 to 1:10. The content of PAA and SBR in the connecting portion can be determined by, as described below in Examples, dyeing PAA and SBR and examining spectrum distribution of an SEM-EDX spectrum.

On the surface of the active material particles in the active material layer, there may be present at least one of PAA and SBR that does not form a connecting portion. Preferably, unlike in the connecting portion, PAA and SBR present on the surface of an active material particle and not forming a connecting portion do not have the first layer and the second layer, and the PAA and the SBR are independently present covering the surface of the active material particle.

The active material layer may include a conductive aid. Examples of the conductive aid include one or more carbon materials selected from the group consisting of fibrous carbon, carbon black (such as acetylene black, Ketjenblack), coke, and activated carbon. Examples of the fibrous carbon include carbon nanotubes (hereinafter also called “CNTs”). CNTs may be single-walled carbon nanotubes (SWCNTs), or may be multi-walled carbon nanotubes such as double-walled carbon nanotubes (DWCNTs). As described above, the connecting portion structurally tends not to be cut but rather follow the expansion and shrinkage of the active material particles during charge and discharge of the secondary battery, and it can also connect between two active material particles that are located relatively far from each other in the active material layer. The conductive aid is placed near the connecting portion and can form conductive paths between the active material particles. With the presence of the connecting portion having the first layer and the second layer as well as the presence of the conductive aid near the connecting portion, good conductive paths that are not easily cut are readily formed in the active material layer. As a result, a secondary battery with excellent cycling performance can be obtained.

The active material layer may include carboxymethylcellulose (CMC). The CMC may be either in acid form or in salt form, preferably in salt form. When CMC is included, a uniform connecting portion tends to be formed in the active material layer.

Preferably, the yield-loop height of the present negative electrode measured by a stiffness test is 18 mm or less, and may be 15 μm or less, or may be 12 μm or less, or may be from 1 to 18 μm, or may be from 2 to 15 μm, or may be from 2 to 12 μm. As described below in Examples, the yield-loop height is measured in the following manner: an active material layer is formed only on one side of the negative electrode current collector to form a one-side electrode plate; both ends of the resultant are brought into contact with each other to form a perfect-circle, single-layered loop, with the active material layer serving as the outer circumferential surface thereof; the outer circumferential surface of the loop is pressed to obtain a stiffness curve, and when the stress reaches a point of curving where the curve changes from a rise to a steep drop, the height of the loop at this time is regarded as the yield-loop height. The yield-loop height can be adjusted by changing the type of SBR included in the active material layer, for example.

### (Method of Producing Negative Electrode)

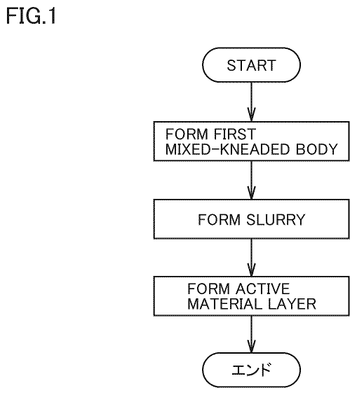

FIG. 1 is a flowchart illustrating a method of producing a negative electrode according to an embodiment. The method of producing a negative electrode according to the present embodiment is capable of producing a negative electrode for a secondary battery, and it is also capable of producing the present negative electrode. The method of producing a negative electrode includes a first step to obtain a first mixed-kneaded body (a mixed-kneaded body), a second step to obtain a slurry by using the first mixed-kneaded body, and a third step to form an active material layer by using the slurry (FIG. 1). The first step includes a step to mix and knead active material particles, a polyacrylic acid hydrate obtainable by hydration of PAA (hereinafter also called “a PAA hydrate”), and water. The active material particles include carbon-based particles and metal-based particles. As each of the active material particles (carbon-based particles and metal-based particles) and PAA, the above-mentioned material may be used. The second step of the method of producing a negative electrode includes a step to add SBR and water to the first mixed-kneaded body and mix and knead.

When an ideal solid content B0 [weight %] is defined as a solid content of a mixture (mixed powder) of the active material particles and PAA mixed in the same ratio as in the first mixed-kneaded body at which a torque produced by mixing and kneading the mixture with addition of water thereto reaches maximum, the solid content of the first mixed-kneaded body is from (B0-5) to B0 [weight %], and the solid content of the slurry is from (B0-25) to (B0-10) [weight %].

The ideal solid content B0 [weight %] can be calculated by the equation given below; in the equation, A0 [weight %] is defined as the water content at which the torque required for mixing and kneading a mixture (mixed powder) of the active material particles and PAA mixed in the above-mentioned ratio, with addition of water thereto, reaches maximum, and A1 [mL] is defined as the water amount per 100 g of the mixture (mixed powder) corresponding to the water content A0 [weight %]. For example, the ideal solid content B0 [weight %] is from 55 to 75%.

$$B 0 [ weight \% ] = 100 - A 0 = \{ 100 / ( 100 + A 1 ) \} \times 100$$

The solid content of the first mixed-kneaded body is from (B0-5) to B0 [weight %], and it may be from (B0-4) to B0 [weight %], or may be from (B0-3) to B0 [weight %], or may be not less than (B0-2) [weight %] and less than B0 [weight %]. The solid content of the first mixed-kneaded body is calculated as the ratio [weight %] of the weight of solid matter (components other than water) to the total weight of the first mixed-kneaded body. In the case where mixing and kneading is carried out in such a manner that the solid content of the resulting first mixed-kneaded body falls within the above-mentioned range, the first layer of the connecting portion can be formed in a proper fashion between the active material particles.

The ratio between PAA and water in the PAA hydrate, namely, PAA:water (weight ratio), may be from 1:1 to 1:100, or may be from 1:1 to 1:50, or may be from 1:2 to 1:20, or may be from 1:5 to 1:10, or may be 1:1. The method of producing a negative electrode may have, before the first step, a step to mix PAA and water together for hydration of the PAA to obtain a PAA hydrate. The ratio of PAA and water used for the PAA hydration may be within the range of the ratio between PAA and water included in the PAA hydrate. In the case where the PAA hydrate is used in the first step, the first layer of the connecting portion between the active material particles can be formed thicker.

The step to mix and knead in the first step may be carried out with further addition of CMC. More specifically, in the first step, the active material particles, the PAA hydrate, and water as well as CMC may be added, and mixed and kneaded. As the CMC, the above-mentioned material may be used. The first step is a step of high-shear kneading, so the active material particles and the PAA hydrate tend to become aggregated. In the case where CMC is added in the first step, aggregation of the active material particles and the PAA hydrate can be reduced and, thereby, the active material particles and the PAA can be dispersed well. This makes it possible to form the first layer of the connecting portion uniformly between the active material particles in the active material layer.

In the case where CMC is added and mixed and kneaded in the first step, the method of producing a negative electrode may have, before the first step, a step to dry mix the active material particles and CMC to obtain a mixed powder. In this case, the first step may perform mixing and kneading the mixed powder, the PAA hydrate, and water to obtain the first mixed-kneaded body.

The step to mix and knead in the first step may be carried out with further addition of a conductive aid. More specifically, in the first step, the active material particles, the PAA hydrate, and water as well as a conductive aid may be added, and mixed and kneaded. As the conductive aid, the above-mentioned material may be used. In the case where CMC and the conductive aid are added and mixed and kneaded in the first step, the first step may mix and knead the mixed powder, the PAA hydrate, the conductive aid, and water. In the case where the conductive aid is mixed and kneaded in the first step, the conductive aid can be disposed near the connecting portion, and thereby good conductive paths can be formed in the active material layer.

The first step may be carried out by using a stirrer equipped with a stirring blade. The number of revolutions of the stirring blade in the first step is not particularly limited, and it may be from 40 to 70 rpm, or may be from 45 to 65 rpm, or may be from 50 to 55 rpm, for example. The duration of mixing and kneading in the first step may be from 100 to 200 min, or may be from 20 to 120 min, or may be from 30 to 100 min, for example.

The second step is carried out for adjusting the solid concentration of the slurry. The solid content of the slurry is from (B0-25) to (B0-10) [weight %], and it may be from (B0-22) to (B0-11) [weight %], or may be from (B0-18) to (B0-12) [weight %], or may be from (B0-16) to (B0-11) [weight %]. The solid content of the slurry is calculated as the ratio [weight %] of the weight of the solid matter (components other than water) to the total weight of the slurry.

The SBR added in the second step may be added in the form of an SBR aqueous solution. The second step may include a step (2.1) to mix and knead the first mixed-kneaded body and water to obtain a second mixed-kneaded body, and a step (2.2) to mix the second mixed-kneaded body and SBR (SBR aqueous solution). In the case where SBR and water are added to the first mixed-kneaded body in the second step, the second layer including SBR can be formed on the surface of the first layer that is formed between the active material particles.

The second step may be carried out by using a stirrer equipped with a stirring blade. The number of revolutions of the stirring blade in the second step is not particularly limited, and it may be from 10 to 40 rpm, or may be from 20 to 35 rpm, or may be from 25 to 30 rpm, for example. The duration of stirring in the second step may be from 10 to 90 min, or may be from 15 to 60 min, or may be from 20 to 50 min, for example. The duration of mixing and kneading in the step (2.1) may be from 15 to 45 min, or may be from 20 to 40 min, for example. The duration of mixing in the step (2.2) may be from 1 to 20 min, or may be from 5 to 15 min, for example. The duration of mixing and kneading in the step (2.1) may be longer than the duration of mixing in the step (2.2).

The third step is a step to form the active material layer by using the slurry prepared in the second step. The third step can include a step to apply the slurry to a negative electrode current collector to form a coating layer and dry the coating layer, and it may further include a step to compress the dried coating layer. As the negative electrode current collector, the above-mentioned material may be used.

### (Non-Aqueous Electrolyte Secondary Battery)

A non-aqueous electrolyte secondary battery according to the present embodiment (hereinafter also called “the present battery”) includes the present negative electrode, and, usually, it includes an electrode assembly that includes the present negative electrode, and a non-aqueous electrolyte solution. The present battery may have a battery case for accommodating the electrode assembly and the non-aqueous electrolyte solution. The battery case can include an exterior package having an opening, as well as a sealing plate for sealing the opening. Each of the exterior package and the sealing plate is preferably made of metal, can be formed by using aluminum, aluminum alloy, iron, iron alloy, or the like, and, for example, can be formed by using an aluminum laminated film. Between the electrode assembly and the exterior package, a resin sheet may be provided as an electrode holder.

The electrode assembly may include the present negative electrode, a positive electrode, and a separator. In the electrode assembly, the active material layer of the present negative electrode faces a positive electrode active material layer of the positive electrode, with the separator interposed therebetween. The electrode assembly may be a stack-type one that is formed by stacking the present negative electrode, the positive electrode, and the separator, or may be a wound-type one that is formed by stacking the present negative electrode, the positive electrode, and the separator and winding the resulting stack.

The positive electrode usually has a positive electrode current collector and a positive electrode active material layer, and, for example, the positive electrode current collector is a metal foil that is made by using an aluminum material such as aluminum and aluminum alloy. The positive electrode active material layer includes positive electrode active material particles, and may further include a conductive material, a binder, and the like. Examples of the positive electrode active material particles include particles of a lithium transition metal oxide of layered type, spinel type, or the like (for example, LiNiCoMnO₂, LiNiO₂, LiCoO₂, LiFeO₂, LiMn₂O₄, LiNi_{0.5}Mn_{1.5}O₄, LiCrMnO₄, LiFePO₄, LiNi_{1/3}Co_{1/3}Mn_{1/3}O₂). The lithium transition metal oxide may be lithium-nickel-cobalt-manganese composite oxide (NCM). Examples of the conductive material include carbon materials such as fibrous carbon (CNTs (SWCNTs, DWCNTs)), carbon black (for example, acetylene black, Ketjenblack), coke, activated carbon, and the like. Examples of the binder include polyvinylidene difluoride (PVdF), polytetrafluoroethylene (PTFE), SBR, and the like.

The separator has a base material, and may have a functional layer on at least one side of the base material. The base material can be a porous sheet such as a film and a nonwoven fabric made of a resin such as polyethylene, polypropylene, polyester, cellulose, and/or polyamide. The base material may have a monolayer structure or a multilayer structure. The functional layer may be, for example, either an adhesive layer or a heat-resistant layer, or both. The adhesive layer can be formed with an adhesive agent, for example. The heat-resistant layer can include a filler and a binder, for example.

The non-aqueous electrolyte solution is preferably obtained by adding a supporting salt to a non-aqueous solvent such as an organic solvent. Examples of the supporting salt include LiPF₆, LiBF₄, LiClO₄, LiFSO₃, LiBOB (lithium bis(oxalato)borate), and the like. The non-aqueous electrolyte solution may include one, two, or more supporting salts, among these. Examples of the non-aqueous solvent include ethylene carbonate (EC), ethyl methyl carbonate (EMC), dimethyl carbonate (DMC), propylene carbonate (PC), butylene carbonate (BC), diethyl carbonate (DEC), and the like. The non-aqueous electrolyte solution can include one, two, or more non-aqueous solvents, among these.

### (Method of Producing Non-Aqueous Electrolyte Secondary Battery)

The method of producing the present battery includes a step to produce a negative electrode by the method of producing the present negative electrode. The method of producing the present battery may further include a step to obtain an electrode assembly by using the present negative electrode, a positive electrode, and a separator, and a step to place the electrode assembly and a non-aqueous electrolyte solution in a battery case.

### EXAMPLES

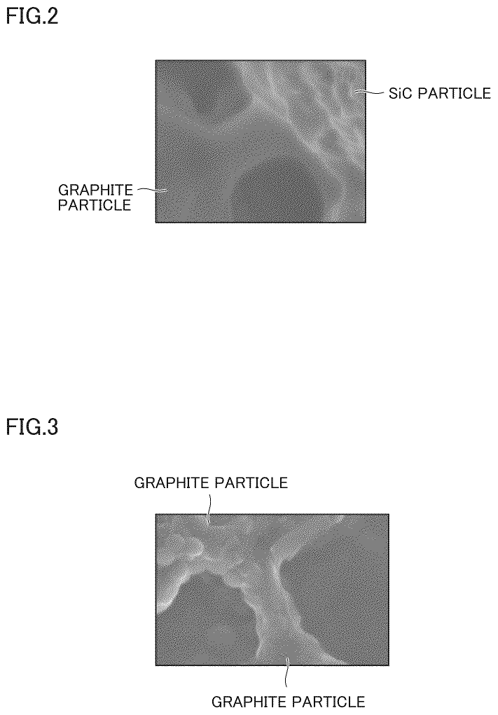

In the following, the present disclosure will be described in further detail by way of Examples and Comparative Examples. FIG. 2 to FIG. 5 are SEM images of active material layers of negative electrodes produced in Examples 1 and 2 as well as Comparative Examples 1 and 2, respectively.

### Example 1

### (Production of Negative Electrode)

Graphite particles were used as carbon-based particles, and particles of a Si—C composite (SiC composite particles) were used as metal-based particles. As a conductive aid, SWCNTs were used. A slurry (1) was prepared by the procedure described below, with the use of a stirrer (manufactured by PRIMIX Corporation, HIVIS MIX 2P-1).

Firstly, PAA powder and water were mixed in a weight ratio of (PAA powder):water=1:1 to obtain a PAA hydrate. The carbon-based particles, the metal-based particles, and CMC were dry mixed to obtain a mixed powder (1). The PAA hydrate, the mixed powder (1), the SWCNTs, and water were mixed and kneaded for 90 min at a solid content of 65 weight % at a number of revolutions of the stirrer of 50 rpm to obtain a first mixed-kneaded body (a first step). Subsequently, the first mixed-kneaded body and water were mixed and kneaded for 30 min at a number of revolutions of the stirrer of 30 rpm to obtain a second mixed-kneaded body, and an SBR aqueous solution was added to the resulting second mixed-kneaded body and mixed for 10 min at a solid content of 50 weight % at a number of revolutions of the stirrer of 30 rpm to obtain a slurry (1) having a solid content of 50 weight % (a second step). The blending ratio for the slurry (1) was (graphite particles):(SiC composite particles):SWCNTs:CMC:PAA:SBR=90:10:0.05:1:1:1 (weight ratio).

The ideal solid content (B0) was 65 weight %, which was calculated by the following equation:

$$B 0 [ weight \% ] = 100 - A 0 = \{ 100 / ( 100 + A 1 ) \} \times 100$$

where A0 [weight %] was defined as the water content at which the torque required for mixing and kneading a mixture of the graphite particles, the SiC composite particles, and PAA mixed in the same ratio as in the first mixed-kneaded body, with addition of water thereto, reaches maximum, and A1 [mL] was defined as the water amount per 100 g of the mixture (mixed powder) corresponding to the water content A0 [weight %]. Accordingly, in the present example, the solid content in the first step was (B0) [weight %] and the solid content of the slurry (1) was (B0-15) [weight %].

The slurry (1) obtained in the above-mentioned manner was applied to both sides of a copper foil having a thickness of 8 μm serving as a negative electrode current collector, and dried and compressed to obtain a negative electrode (1). The mass of the active material layer of the negative electrode (1) per unit area (the total mass per unit area for both sides) was 215 g/m², the thickness of the active material layer (per one side) was 135 μm, and the packing density of the active material layer was 1.60 g/cc. As seen in FIG. 2, in the active material layer of the negative electrode (1), a thick columnar connecting portion having a first layer as well as a second layer formed on the surface of the first layer was formed between two active material particles, and both ends of the first layer and the second layer were in contact with the surface of the active material particles. Although FIG. 2 shows a connecting portion formed between a graphite particle and a SiC composite particle, connecting portions were also formed in the same manner between graphite particles and between SiC composite particles.

### (Production of Positive Electrode)

Lithium-nickel-cobalt-manganese composite oxide (NCM) as positive electrode active material particles, acetylene black (AB) as a conductive material, and polyvinylidene difluoride (PVdF) as a binder were used in a weight ratio of (positive electrode active material particles):AB:PVdF=100:1:1, and they were mixed with N-methylpyrrolidone (NMP) as a solvent to obtain a positive electrode composite material slurry. The resulting positive electrode composite material slurry was applied to an aluminum foil having a thickness of 15 μm serving as a positive electrode current collector, and dried and compressed to obtain a positive electrode.

### (Production of Non-Aqueous Electrolyte Secondary Battery)

A lead was attached to each of the negative electrode and the positive electrode obtained in the above-mentioned manner, and the negative electrode and the positive electrode were stacked on top of one another with a separator interposed therebetween, to obtain an electrode assembly. The resulting electrode assembly was inserted into an exterior package made of an aluminum-laminated sheet, and a non-aqueous electrolyte solution was injected, followed by sealing the opening of the exterior package to obtain a test cell (a laminated cell) (1). The non-aqueous electrolyte solution was a mixed solvent that contained ethylene carbonate (EC), ethyl methyl carbonate (EMC), and dimethyl carbonate (DMC) in a volume ratio of EC:EMC:DMC=30:30:40, in which LiPF₆ as a lithium salt was dissolved in a concentration of 1 mol/L.

### Example 2

A slurry (2) was prepared and a negative electrode (2) and a test cell (2) were obtained by the same procedure as in Example 1 except that the type of SBR included in the SBR aqueous solution was changed. The SBR used in the present example was hard and less likely to collapse as compared with the SBR used in Example 1. As seen in FIG. 3, in the active material layer of the negative electrode (2), a thick columnar connecting portion having a first layer as well as a second layer formed on the surface of the first layer was formed between two active material particles, and both ends of the first layer and the second layer were in contact with the surface of the active material particles. Although FIG. 3 shows a connecting portion formed between graphite particles, connecting portions were also formed in the same manner between SiC composite particles and between a graphite particle and a SiC composite particle.

### Comparative Example 1

### (Production of Negative Electrode)

By the procedure described below, a slurry (c1) was prepared and a negative electrode (c1) was obtained. The carbon-based particles, the metal-based particles, the PAA powder, the SWCNTs, the SBR, and the stirrer used in this Comparative Example were the same as those used in the production of negative electrode in Example 1.

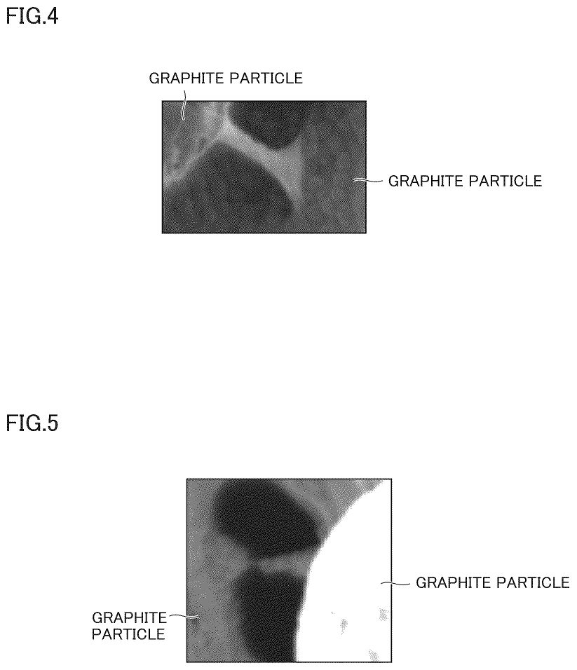

Firstly, the carbon-based particles, the metal-based particles, PAA powder, and CMC were dry mixed to obtain a mixed powder (c1). The resulting mixed powder (c1), SWCNTs, an SBR aqueous solution, and water were mixed and kneaded at a solid content of 65 weight % to obtain a mixed-kneaded body. Subsequently, the resulting mixed-kneaded body and water were mixed and kneaded to obtain a slurry (c1) having a solid content of 50 weight %. The blending ratio between the components were the same as in Example 1. By the same procedure as employed for the production of negative electrode in Example 1 except that the slurry (c1) was used instead of the slurry (1), a negative electrode (c1) was obtained. As seen in FIG. 4, in the active material layer of the negative electrode (c1), a monolayer, thin, columnar connecting portion formed of a mixture of PAA and SBR was formed between two active material particles. Although FIG. 4 shows a connecting portion formed between graphite particles, connecting portions formed between SiC composite particles and those between a graphite particle and a SiC composite particle were also monolayer, thin, and columnar.

### (Production of Non-Aqueous Electrolyte Secondary Battery)

A test cell (c1) was obtained by the same procedure as employed for the production of non-aqueous electrolyte secondary battery in Example 1 except that the negative electrode (c1) was used instead of the negative electrode (1).

### Comparative Example 2

### (Production of Negative Electrode)

By the procedure described below, a slurry (c2) was prepared and a negative electrode (c2) was obtained. The carbon-based particles, the metal-based particles, the PAA powder, the SWCNTs, the SBR, and the stirrer used in this Comparative Example were the same as those used in the production of negative electrode in Example 1.

Firstly, the carbon-based particles, the metal-based particles, PAA powder, and CMC were dry mixed to obtain a mixed powder (c2). The resulting mixed powder (c2), SWCNTs, an SBR aqueous solution, and water were mixed and kneaded at a solid content of 50 weight % to obtain a slurry (c2) having a solid content of 50 weight %. The blending ratio between the components were the same as in Example 1. By the same procedure as employed for the production of negative electrode in Example 1 except that the slurry (c2) was used instead of the slurry (1), a negative electrode (c2) was obtained. As seen in FIG. 5, the structure formed between two active material particles in the active material layer of the negative electrode (c2) was a columnar structure separated in part or a very thin columnar structure, and was monolayered. Although FIG. 5 shows a structure formed between graphite particles, structures formed between SiC composite particles and those formed between a graphite particle and a SiC composite particle were similar.

### (Production of Non-Aqueous Electrolyte Secondary Battery)

A test cell (c2) was obtained by the same procedure as employed for the production of non-aqueous electrolyte secondary battery in Example 1 except that the negative electrode (c2) was used instead of the negative electrode (1).

### [Measurement of Connecting Portion]

### (Content of PAA and SBR)

The content of PAA and SBR in the connecting portion was measured by the procedure described below. By a staining method, PAA was stained with osmium (Os) and SBR was stained with ruthenium (Ru) to visualize the binder components. Subsequently, spectrum distribution was examined for an SEM-EDX spectrum to determine the content of PAA and SBR in the connecting portion (volume ratio). Results are given in Table 1.

### (Length and Diameter)

The length and the diameter of the connecting portion were measured for a connecting portion in an SEM image, and the average values were regarded as the length and the diameter of the connecting portion, respectively.

### [Evaluation of Cycling Performance]

In an environment at 25° C., the test cell was charged and discharged for multiple cycles, where one cycle consisted of charging by constant-current-constant-voltage charging (CCCV) at a value of current of 0.2 C to reach 4.15 V and 0.1 C and then discharging at a value of current of 0.33 C to reach 3 V (CC discharging). By the following equation, the discharged capacity at the 200th cycle relative to the discharged capacity at the first cycle was calculated, which was regarded as cycle retention [%]. Results are given in Table 1.

$$Cycle retention [ \% ] = ( ( Discharged capacity at the 200 th cycle ) / ( Discharged capacity at the first cycle ) ) \times 100$$

### [Stiffness Test]

The active material layer was peeled off from one side of the negative electrode to form a one-side electrode plate which had an active material layer only on one side of the negative electrode current collector, and the resultant was cut into a size of 10 mm in width and 80 mm in length. Both ends of the cut-out one-side electrode plate in the length direction were brought into contact with each other to form a single-layered perfect circle, with the active material layer serving as the outer circumferential surface thereof, to form a measurement sample having an outer circumference of 80 mm. The portion of the measurement sample where both ends were in contact with each other was secured to a lower plate of a loop stiffness tester so that the measurement sample was sandwiched between an upper plate and the lower plate. The outer circumferential surface of the measurement sample was pressed to obtain a stiffness curve, and a point of curving was determined at which the curve (the stress generated in the measurement sample) changed from a rise to a steep drop, to measure the distance between the upper plate and the lower plate at this point of curving, which was regarded as the yield-loop height. Results are given in Table 1.

TABLE 1

| | Ex. 1 | Ex. 2 | Comp. Ex. 1 | Comp. Ex. 2 |
|---|---|---|---|---|
| Negative electrode | (1) | (2) | (c1) | (c2) |
| Yield-loop height [μm] | 3 | 4 | ≤18 | ≤18 |
| Connecting portion | | | | |
| Layer structure | First layer, | First layer, | Monolayer | Monolayer |
| | Second layer | Second layer | | |
| Content | 1:3 | 1:3 | | |
| PAA:SBR (volume ratio) | | | | |
| Length [μm] | 1 | 1.5 | 0.8 | 0.5 |
| Diameter [μm] | 0.2 | 0.4 | 0.1 | 0.01 |
| Slurry | (1) | (2) | (c1) | (c2) |
| Method of producing negative | | | | |
| electrode | | | | |
| Hydration of PAA | Yes | Yes | No | No |
| Timing to mix and knead | First step (PAA) | First step (PAA) | In the same | In the same |
| PAA and SBR | Second step (SBR) | Second step (SBR) | step | step |
| Solid content in first step | 65 | 65 | | |
| [weight %] | | | | |
| Solid content in second step | 50 | 50 | | |
| (slurry) [weight %] | | | | |
| Solid content during mixing | | | 65 (During | 50 (During |
| and kneading and of slurry | | | mixing and | mixing and |
| [weight %] | | | kneading) | kneading) |
| | | | 50 (Slurry) | 50 (Slurry) |
| Test cell | (1) | (2) | (c1) | (c2) |
| Cycle retention [%] | 95 | 94 | 86 | 86 |

Although the embodiments of the present invention have been described, the embodiments disclosed herein are illustrative and non-restrictive in any respect. The scope of the present invention is defined by the terms of the claims, and is intended to encompass any modifications within the meaning and the scope equivalent to the terms of the claims.

What is claimed is:

1. A negative electrode for a non-aqueous electrolyte secondary battery, comprising:
an active material layer including active material particles, wherein
the active material particles include carbon-based active material particles and metal-based active material particles,
the active material layer has a connecting portion connecting a pair of the active material particles to each other,
the connecting portion has a first layer including at least one of polyacrylic acid and a salt thereof as well as a second layer formed on a surface of the first layer and including styrene-butadiene rubber, and
both the first layer and the second layer are in contact with surfaces of the pair of the active material particles connected by the connecting portion.

2. The negative electrode according to claim 1, wherein the carbon-based active material particles include graphite particles.

3. The negative electrode according to claim 1, wherein the metal-based active material particles include particles of one or more types selected from the group consisting of Si, SiOx, and a Si—C composite.

4. The negative electrode according to claim 1, wherein the connecting portion at least connects the carbon-based active material particle with the metal-based active material particle.

5. The negative electrode according to claim 1, wherein the active material layer further includes a conductive aid.

6. The negative electrode according to claim 1, wherein the active material layer further includes carboxymethylcellulose.

7. A non-aqueous electrolyte secondary battery comprising the negative electrode according to claim 1.

8. A method of producing a negative electrode for a non-aqueous electrolyte secondary battery, the negative electrode having an active material layer including active material particles, the method comprising:
a first step to obtain a mixed-kneaded body;
a second step to obtain a slurry by using the mixed-kneaded body; and
a third step to form the active material layer by using the slurry, wherein
the first step includes a step to mix and knead active material particles, a polyacrylic acid hydrate obtainable by hydration of at least one of polyacrylic acid and a salt thereof, and water,
the active material particles include carbon-based active material particles and metal-based active material particles,
the second step includes a step to add styrene-butadiene rubber and water to the mixed-kneaded body and mix and knead, and
when an ideal solid content B0 [weight %] is defined as a solid content of a mixture of the active material particles and the at least one of polyacrylic acid and a salt thereof mixed in the same ratio as in the mixed-kneaded body at which a torque produced by mixing and kneading the mixture with addition of water thereto reaches maximum,
a solid content of the mixed-kneaded body is from (B0-5) to B0 [weight %], and
a solid content of the slurry is from (B0-25) to (B0-10) [weight %].

9. The method of producing a negative electrode according to claim 8, wherein the step to mix and knead in the first step is carried out with further addition of carboxymethylcellulose.

10. The method of producing a negative electrode according to claim 8, wherein the step to mix and knead in the first step is carried out with further addition of a conductive aid.

11. The method of producing a negative electrode according to claim 8, wherein the carbon-based active material particles include graphite particles.

12. The method of producing a negative electrode according to claim 8, wherein the metal-based active material particles include particles of one or more types selected from the group consisting of Si, SiOx, and a Si—C composite.

13. A method of producing a non-aqueous electrolyte secondary battery, the method comprising a step to produce a negative electrode by the method of producing a negative electrode according to claim 8.
